(19) United States
(12) Patent Application Publication
(10) Pub. No.: US 2013/0257707 A1
(43) Pub. Date: Oct. 3, 2013

(54) LED DRIVING DEVICE AND LED DRIVING METHOD

(71) Applicant: NEC CORPORATION, Tokyo (JP)

(72) Inventor: Satomi MATSUMURA, Tokyo (JP)

(73) Assignee: NEC CORPORATION, Tokyo (JP)

(21) Appl. No.: 13/758,322

(22) Filed: Feb. 4, 2013

(30) Foreign Application Priority Data
Mar. 29, 2012 (JP) 2012-075306
Dec. 26, 2012 (JP) 2012-283137

(51) Int. Cl. H05B 33/08; G09G 3/34

(52) U.S. Cl. CPC H05B 33/0833; G09G 3/3413
USPC 345/102; 315/307

(57) ABSTRACT

Disclosed is a LED lighting device or the like able to light and extinguish a LED, which has quick response properties to the flicker, with using composition of a simple power source circuit and maintaining softness for user's eyes.

In the case that a direct current power source 1 starts applying a voltage to a LED 4, the LED driving device controls an amount of light of the LED 4 to increase as the time passes. In the case that the direct current power source 1 ends applying the voltage to the LED 4, the LED driving device controls an amount of the light of the LED 4 to decrease as the time passes.

This application is based upon and claims the benefit of priority from Japanese Patent Application No. 2012-075306, filed on 29 Mar. 2012, the disclosure of which is incorporated herein in its entirety by reference.

### TECHNICAL FIELD

The present invention relates to a LED driving device or the like which drives a LED (Light Emitting Diode) by a direct current power source.

### BACKGROUND ART

Since a LED has a long life and less power consumption in comparison with a light bulb which uses a filament, and a fluorescent lamp, and furthermore has quick response properties to a flicker, the LED is prevailing rapidly to be used in an illumination device, a backlight device of a TV set or the like, various display equipments such as an indicator lamp and a meter, or the like.

As a related art, the art which makes a LED light when a voltage of a condenser becomes not lower than a predetermined value through making the condenser accumulate an electric charge by use of a minute-level oscillation voltage of a high frequency power source, is disclosed in Japanese Patent Application Laid-Open Publication No. 1996-264282. According to the art described in the Laid-Open Publication, when a filament of an incandescent lamp which is lighted by the high frequency power source is burned out, the condenser connected in parallel with a rectification circuit, which has a bypass connection with the high frequency power source, accumulates gradually the electric charge by use of the minute-level oscillation voltage of the high frequency power source. For this reason, the LED, which is connected in parallel with the condenser, becomes bright gradually as the voltage of the condenser becomes high. As a result, it is possible for a user to check whether a lighting circuit of the high frequency power source is operating or not through checking a state of the LED's lighting even when the incandescent lamp is burned out, according to the art described in the Laid-Open Publication.

### SUMMARY

However, the LED has very quick response properties to the flicker since an amount of light of the LED is changed quickly, and consequently brightness, which is felt in the case of lighting or extinguishing the LED, is changed quickly. Therefore, an aperture function of an iris of the user may not follow the flicker of the LED to make the user feel glaring in some cases.

The art described in Japanese Patent Application Laid-Open Publication No. 1996-264282 makes the LED light through making the condenser accumulate the electric charge, which is inputted into the condenser when the incandescent lamp is burned out, by use of the minute-level oscillation voltage. However, according to the art, it is impossible to reduce the glare which the user feels due to the steep change of the light amount in the case of that the LED is lighted.

The present invention is conceived with taking the circumstances mentioned above into consideration. A main object of the present invention is to provide a LED driving device or the like able to reduce the glare, which the user feels, due to the steep change in the intensity of light which is caused in the case of lighting or extinguishing the LED.

In order to achieve the above-mentioned object, the LED driving device according to the present invention is characterized in that the LED driving device controls an amount of light of a LED to increase as the time passes in the case that a direct current power source starts applying a voltage to the LED, and controls an amount of the light of the LED to decrease as the time passes in the case that the direct current power source ends applying the voltage to the LED.

Moreover, a LED driving method according to the present invention is characterized in that a control circuit is arranged between a direct current power source which drives a LED, and the LED, and the LED driving method includes a process of making an amount of light of the LED increase as the time passes in the case of starting applying a voltage to the LED, and making an amount of the light of the LED decrease as the time passes in the case of ending applying the voltage to LED.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

Exemplary features and advantages of the present invention will become apparent from the following detailed description when taken with the accompanying drawings in which:

FIG. 1 is a circuit diagram of a LED driving device according to a first exemplary embodiment of the present invention;

FIG. 2 is a circuit diagram of a LED driving device according to a second exemplary embodiment of the present invention;

FIG. 3 is a diagram of exemplifying a waveform of a voltage which is applied to a LED by the LED driving device shown in FIG. 2;

FIG. 4 is a circuit diagram of a LED driving device according to a third exemplary embodiment of the present invention; and

FIG. 5 is a diagram showing properties that a light passing rate of a liquid crystal display panel of the LED driving device shown in FIG. 4 changes as the time passes.

### EXEMPLARY EMBODIMENT

Hereinafter, an exemplary embodiment according to the present invention will be described in detail with reference to drawings.

Firstly, a LED driving device according to the exemplary embodiment of the present invention is realized with composition which will be described in the following.

(1) A condenser capacitor, which is charged through a resistor, is arranged at an output side of a direct current power source as a control circuit, and a voltage, which is applied to a LED connected in parallel with the condenser, is increased gradually through increasing a voltage of the condenser gradually according to a CR (Condenser and Resistor) time constant. As a result, the intensity of light of the LED is strong gradually.

(2) A driving circuit, which carries out PWM (Pulse Width Modulation) control by use of a direct current power source, is arranged at an output side of the direct current power source as a control circuit, and a voltage of the condenser is applied to a LED with charging the condenser by use of an output voltage of the driving circuit through enlarging the duty ratio of a PWM waveform gradually. As a result, it is possible to make the intensity of illumination of the LED strong gradually.

(3) A light passing rate of a liquid crystal display panel, which is arranged in front of a LED used as the backlight, is made high gradually through changing gradually a voltage which is applied to the liquid crystal display panel. As a result, it is possible to make the intensity of light of the LED strong gradually.

According to the above-mentioned LED driving method, since it is possible to make transient properties (change which is generated as the time passes) of a state of the LED's lighting, which are generated in the case of lighting or extinguishing the LED having the quick response properties to the flicker, be close to a work which the light bulb using the filament carries out in the case of lighting or extinguishing the light bulb using the filament, it is possible to reduce the glare which the user feels due to the LED.

Next, several exemplary embodiments, which are more specific, on the LED driving device mentioned above will be described in detail with reference to a drawings. Here, in all drawings which describe all the exemplary embodiments, a common component has a common code as a principle, and repetitive description on the common component is omitted.

### First Exemplary Embodiment

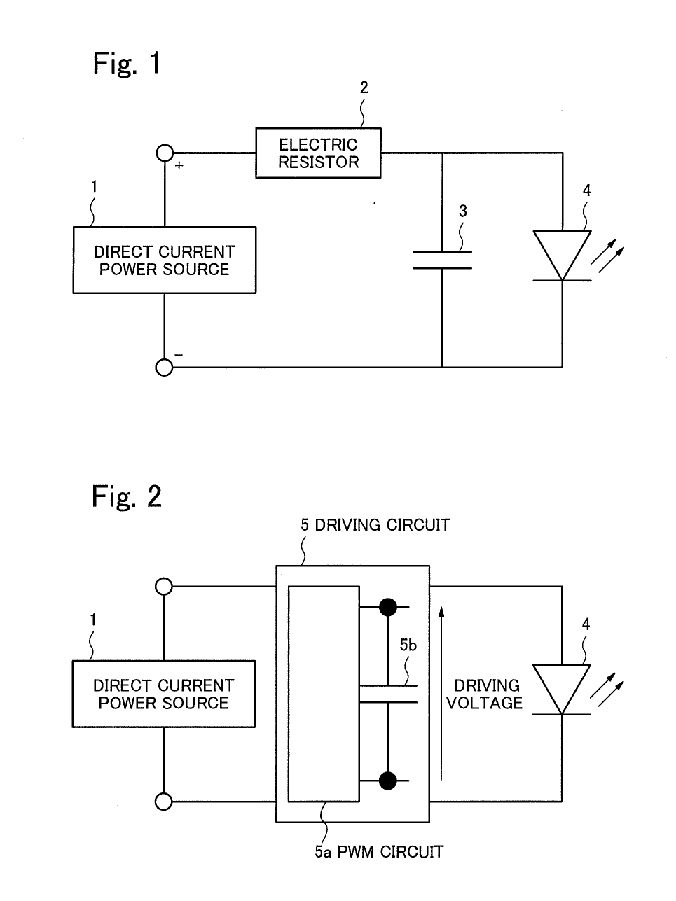

FIG. 1 is a circuit diagram showing a LED driving device according to a first exemplary embodiment of the present invention. According to the LED driving device, one end of an electric resistor 2 is connected with a plus side terminal of a direct current power source 1, and the other end of the electric resistor 2 is connected with a plus side terminal of a condenser 3. Moreover, according to the LED driving circuit, a minus side terminal of the condenser 3 is connected with a minus side terminal of the direct current power source 1, and an anode of a LED 4 is connected with the plus side terminal of the condenser 3, and a cathode of the LED 4 is connected with the minus side terminal of the condenser 3.

That is, while the plus side terminal of the direct current power source 1 is connected with only the electric resistor 2 which is used as a current limiting electric resistor, and is connected with the anode of the LED 4 through the electric resistor 2 according to an usual LED driving device. However, according to the LED driving device of the exemplary embodiment, the LED 4 and the condenser 3 are connected each other in parallel at an output side of the electric resistor 2. According to the LED driving device of the exemplary embodiment, a CR time constant circuit is configured by the electric resistor 2 which is used as the current limiting circuit, and the condenser 3 through connecting the electric resistor 2 and the condenser 3 each other in parallel.

Accordingly, when the LED driving device according to the exemplary embodiment is activated, the condenser 3 is charged by a voltage, which is applied by the direct current power source 1, in a transient situation (situation which is changed as the time passes) dependent on a CR time constant which is determined by the electric resistor 2 and the condenser 3. Therefore, since a voltage of the condenser 3 becomes high gradually, a voltage applied to the LED 4 also becomes high gradually. Therefore, an amount of light of the LED 4 increases gradually in the case that the LED driving device starts working. As a result, it is possible to prevent the LED 4 from being brightened steeply.

Moreover, in the case that the LED driving device stops working (that is, in a stopping process), the voltage which is charged in the condenser 3 is discharged to the direct current power source 1 side in a state dependent on the CR time constant which is determined by the electric resistor 2 and the condenser 3. Therefore, since the voltage of the condenser 3 is lowered gradually, the voltage applied to the LED 4 is also lowered gradually. As a result, since an amount of the light of the LED 4 decreases gradually in the case that the LED driving device stops working, it is possible to prevent a state of the LED 4's lighting from entering into a darkened state steeply.

That is, in the case that the LED driving device according to the exemplary embodiment starts or stops working, the voltage of the condenser 3 becomes gradually high or low respectively on the basis of the CR time constant which is determined by the electric resistor 2 and the condenser 3. Therefore, since the voltage applied to the LED 4, which is connected in parallel with the condenser 3, becomes high or low gradually, it is possible to prevent an amount of the light of the LED 4 from changing steeply. As a result, according to the exemplary embodiment, it is possible to realize illumination which is soft for user's eyes.

### Second Exemplary Embodiment

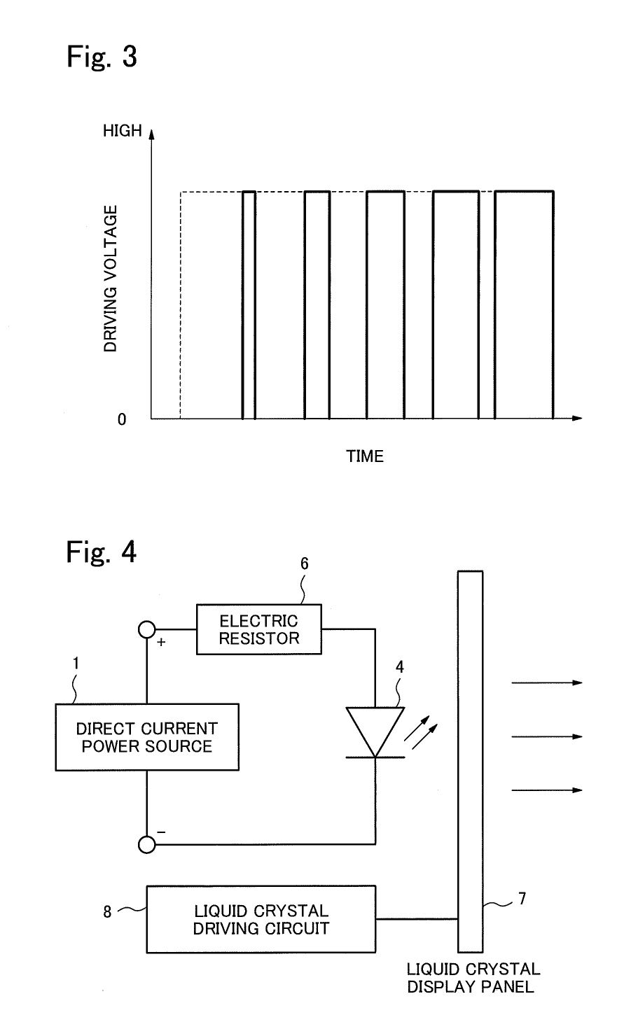

FIG. 2 is a circuit diagram of a LED driving device according to a second exemplary embodiment of the present invention. FIG. 3 exemplifies a waveform of a voltage which is applied to a LED by the LED driving device shown in FIG. 2. In FIG. 3, the horizontal axis indicates a time, and the vertical axis indicates a driving voltage.

As shown in FIG. 2, a driving circuit 5 is connected with the direct current power source 1 according to the LED driving device of the second exemplary embodiment. The driving circuit 5 carries out PWM (Pulse Width Modulation) control. The LED 4, which is connected with the driving circuit 5, is driven by an output of the driving circuit 5 which is corresponding to a driving power source. As shown in FIG. 2, the driving circuit 5 includes a PWM circuit 5a and a condenser 5b which is connected in parallel with an output of the PWM circuit 5a.

That is, as shown in FIG. 3, when the driving circuit 5 is activated, the duty ratio (that is, ratio of an ON period to one cycle period) of PWM carried out by the PWM circuit 5a changes gradually from a minimum value (for example, duty ratio=0.1) to a maximum value (for example, duty ratio=0.9). In this case, it may be applicable to make the maximum value large up to 1.0. As a result, a voltage of the condenser 5b, which is connected in parallel with the output side of the PWM circuit 5a, becomes high gradually.

Therefore, according to the LED driving device of the exemplary embodiment, in the case of activation (that is, in an activating process), for example, one tenths of the power source voltage is applied to the LED 4. Afterward, the voltage applied to LED 4 becomes high gradually. Therefore, an amount of the light of the LED 4 increases gradually in the case of lighting the LED 4. As a result, it is possible to prevent the intensity of light from being strong steeply.

Moreover, according to the LED driving device of the exemplary embodiment, when the driving circuit 5 stops working in the case of extinguishing the LED 4 (that is, in an extinguishing process), the duty ratio of PWM carried out by the PWM circuit 5a becomes small gradually from the maximum value (for example, duty ratio=0.9) to the minimum value (for example, duty ratio=0.1). Accordingly, the voltage of the condenser 5b, which is connected in parallel with the PWM circuit 5a, becomes also low gradually. Therefore, in the case that the LED driving device stops working, the voltage, which is applied to the LED 4, becomes low gradually. As a result, it is possible to prevent the LED 4 from being darkened steeply since an amount of the light of the LED 4 becomes decreasing gradually also in the case that the LED driving device stops working.

That is, according to the LED driving device of the second exemplary embodiment, through driving the LED 4 by the PWM control carried out by the PWM circuit 5a of the driving circuit 5, it is possible to control the duty ratio in the PWM control appropriately. Therefore, it is possible to prevent the steep change in the brightness of the LED 4 since the voltage, which is applied to the LED 4, becomes high or low gradually as the LED 4 is lighted or extinguished (that is, in the case of lighting or extinguishing the LED 4).

### Third Exemplary Embodiment

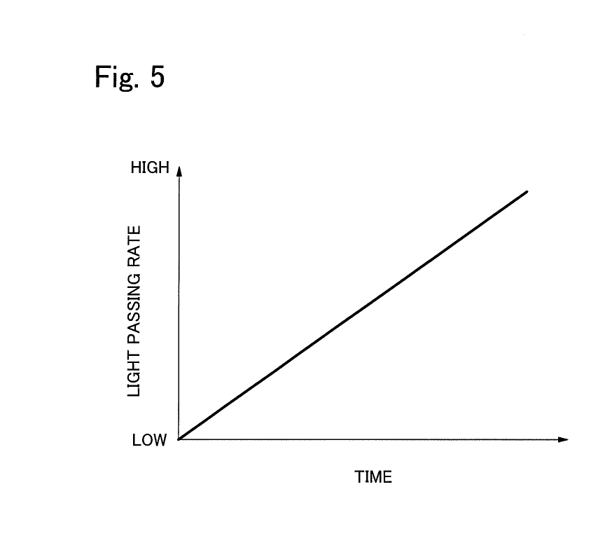

FIG. 4 is a circuit diagram of a LED driving device according to a third exemplary embodiment of the present invention. Moreover, FIG. 5 is a diagram showing properties that light passing rate of a liquid crystal display panel, which is arranged in the LED driving device shown in FIG. 4, is changed sequentially. In FIG. 5, the horizontal axis indicates the time, and the vertical axis indicates the light passing rate of the liquid crystal display panel. According to the LED driving device of the third exemplary embodiment of the present invention, the direct current power source 1, a current limiting electric resistor 6 and the LED 4 are connected each other in series in this order as shown in FIG. 4. Furthermore, according to the LED driving device of the exemplary embodiment, a liquid crystal display panel 7 is arranged at a position near to the LED 4 which is used as the backlight. However, a driving voltage is applied to the liquid crystal display panel 7 by a liquid crystal driving circuit 8.

For example, a liquid crystal display panel, which is based on the normally white method or the normally black method, is applicable to the liquid crystal display panel 7. In the case that the liquid crystal display panel 7 is based on the normally white method, the light passing rate of the liquid crystal display panel 7 is maximum if the voltage applied by the liquid crystal driving circuit 8 is zero, and the light passing rate becomes low gradually as the voltage applied by the liquid crystal driving circuit 8 becomes high. On the other hand, in the case that the liquid crystal display panel 7 is based on the normally black method, the light passing rate of the liquid crystal display panel 7 is minimum if the voltage applied by the liquid crystal driving circuit 8 is zero, and the light passing rate becomes high gradually as the voltage applied by the liquid crystal driving circuit 8 becomes high.

Since a voltage, which is applied to the LED 4 through the current limiting electric resistor 6 by the direct current power source 1, is almost constant, brightness of the LED 4 is almost constant. Here, it is assumed that, in the case that the LED driving device according to the exemplary embodiment is activated, the voltage which is applied to the liquid crystal display panel 7 by the liquid crystal driving circuit 8 is changed. For example, when using the liquid crystal display panel 7 based on the normally white method, the voltage which is applied by the liquid crystal drive circuit 8 is set to be highest in the case of activating the LED driving device. As a result, the light passing rate of the liquid crystal display panel 7 becomes minimum. Then, if the voltage, which is applied by the liquid crystal driving circuit 8, is lowered as the time passes, the light passing rate of the liquid crystal display panel 7 becomes high as the time passes as shown in FIG. 5. As a result, a surface of the liquid crystal display panel 7 becomes bright as the time passes while the surface of the liquid crystal display panel 7, which is illuminated by the LED 4 corresponding to the backlight, is dark in the case of activating the LED driving device.

Moreover, according to the LED driving device of the exemplary embodiment, in the case that the LED driving device stops working, the LED driving device makes the voltage, which is applied by the liquid crystal driving circuit 8, become high gradually before the direct current power source 1 stops applying the voltage. Therefore, the light passing rate of the liquid crystal display panel 7 becomes low gradually. As a result, it is possible to darken gradually the surface of the liquid crystal display panel 7 which is illuminated by the LED 4 corresponding to the backlight. After the voltage, which is applied by the liquid crystal driving circuit 8, becomes maximum, the direct current power source 1 stops applying the voltage.

On the other hand, when using the liquid crystal display panel 7 based on the normally black method, the voltage which is applied by the liquid crystal drive circuit 8 is set to be lowest in the case of activating the LED driving device. As a result, the light passing rate of the liquid crystal display panel 7 becomes minimum. Then, if the voltage, which is applied by the liquid crystal driving circuit 8, is made to become high as the time passes, the light passing rate of the liquid crystal display panel 7 becomes high as the time passes as shown in FIG. 5. As a result, the surface of the liquid crystal display panel 7 becomes bright as the time passes while the surface of the liquid crystal display panel 7, which is illuminated by the LED 4 corresponding to the backlight, is dark in the case of activating the LED driving device.

Moreover, according to the LED driving device, in the case that the LED driving device stops working, the LED driving device makes the voltage, which is applied by the liquid crystal driving circuit 8, low gradually before the direct current power source 1 stops applying the voltage. Therefore, the light passing rate of the liquid crystal display panel 7 becomes low gradually. As a result, it is possible to darken gradually the surface of the liquid crystal display panel 7 which is illuminated by the LED 4 corresponding to the backlight. After the voltage, which is applied by the liquid crystal driving circuit 8, becomes minimum, the direct current power source 1 stops applying the voltage.

That is, in the case that the LED 4 is used as the backlight or the like of the liquid crystal display (liquid crystal display panel 7) in the LED driving device according to the third exemplary embodiment, the voltage, which is applied by the liquid crystal driving circuit 8, is changed gradually. As a result of controlling the light passing rate of the liquid crystal display panel 7 which is arranged in front of the LED 4, it is possible to prevent the steep change in the brightness of the surface of the liquid crystal display panel 7.

According to the LED driving device in each the exemplary embodiment of the present invention described above, the voltage, which is applied to the LED 4, is changed gradually through using the CR time constant and changing the duty ratio in the PWM control (first and second exemplary embodiments). As a result, it is possible to change the brightness (intensity of light) of the LED 4 gradually in the case of lighting and extinguishing the LED 4. Or, the light passing rate of the liquid crystal display panel 7 is changed gradually through changing gradually the voltage which is applied to the liquid crystal display panel 7 arranged in front of the LED 4 used as the backlight (third exemplary embodiment). As a result, it is possible to change the brightness of the surface of the liquid crystal display panel 7 gradually.

Next, the LED driving device according to each the exemplary embodiment mentioned above is compared with the related art which is disclosed in Japanese Patent Application Laid-Open Publication No. 1996-264282. According to the related art, the voltage of the condenser, which is connected in parallel with the LED, is made to become high through charging the condenser by the minute-level oscillation voltage outputted by the high frequency power source. Therefore, it is unnecessary to arrange the CR time constant circuit. That is, according to the related art, the electric resistor, which is arranged at the output side of the condenser, is the current limiting electric resistor of a LED and not a component of the CR time constant circuit. On the other hand, according to the LED lighting circuit of the first exemplary embodiment, the CR time constant circuit is composed through arranging the electric resistor 2 at the input side of the condenser 3. Therefore, the voltage (voltage of condenser), which is applied to the LED 4, can be made high gradually. For this reason, the CR time constant circuit is a mandatory component according to the first exemplary embodiment.

While several exemplary embodiments of the present invention have been described in detail, specific composition of the present invention is not limited to the contents of the exemplary embodiment mentioned above. If a design change or the like is made without departing from the sprit and scope of the present invention, the present invention includes the design change or the like. For example, voltage control by software, which makes the transient properties of the brightness gradual in the case that the LED 4 flickers, can make the transient properties be close to the flicker of the light bulb which uses the filament.

Here, it is possible to realize the direct current power source 1, which is described in each the exemplary embodiment mentioned above, through using an alternating current power source such as the commercial power source as an input power source, a rectifying circuit and a condenser.

According to the present invention which has been described with exemplifying each the exemplary embodiment mentioned above, it is possible to make the transient change in the brightness (that is, intensity of light) gradual in the case of lighting or extinguishing the LED. The present invention can be used effectively in various electronic devices (electric device) such as an illumination device, a backlight type liquid crystal display of a TV set or the like, an indicator lamp or the like. Specifically, the present invention can be used effectively, for example, in an indicator and a seven segment indicator which indicate an operational state of various devices, and a brake lamp, a winker and a light of a vehicle.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.”

### DESCRIPTION OF THE CODES

1 direct current power source
2 electric resistor
3 condenser
4 LED
5 driving circuit
5a PWM circuit
5b condenser
6 current limiting electric resistor
7 liquid crystal display panel
8 power source driving circuit

What is claimed is:

1. A LED driving device, in the case that a direct current power source starts applying a voltage to a LED, controls an amount of light of the LED to increase as the time passes, and in the case that the direct current power source ends applying the voltage to the LED, controls an amount of the light of the LED to decrease as the time passes.

2. The LED driving device according to claim 1, comprising:
a voltage changing means which realizes a change in an amount of the light of the LED through making the voltage, which is applied to the LED, high or low as the time passes.

3. The LED driving device according to claim 2, wherein
in the case of lighting the LED, the voltage changing means makes an output voltage high as the time passes, and in the case of extinguishing the LED, the voltage changing means makes the output voltage low as the time passes.

4. The LED driving device according to claim 2 or claim 3, wherein
the voltage changing means is a driving circuit including a PWM circuit which changes the duty ratio of an output voltage gradually through carrying out the pulse width modulation, and a condenser which is connected in parallel with an output side of the PWM circuit.

5. The LED driving device according to claim 4, wherein
in the case of lighting the LED, the PWM circuit makes the duty ratio large gradually, and in the case of extinguishing the LED, the PWM circuit makes the duty ratio small gradually.

6. The LED driving device according to claim 2 or claim 3, wherein
the voltage changing means is a CR time constant circuit including an electric resistor which is connected in series with the direct current power source, and a condenser which is connected in parallel with the direct current power source through the electric resistor.

7. The LED driving device according to claim 1, comprising:
a liquid crystal driving circuit which changes light passing rate of a liquid crystal display panel, which is illuminated by the LED, through changing a voltage which is applied to the liquid crystal display panel.

8. The LED driving device according to claim 7, wherein
the liquid crystal display panel is based on the normally white method; and
in the case of lighting the LED, the liquid crystal driving circuit makes the voltage, which is applied to the liquid crystal display panel, to be lower gradually than a voltage which is high relatively, and in the case of extinguishing the LED, the liquid crystal driving circuit makes the voltage, which is applied to the liquid crystal display panel, to be higher gradually than a voltage which is low relatively.

9. The LED driving device according to claim 8, wherein
the liquid crystal display panel is based on the normally black method; and
in the case of lighting the LED, the liquid crystal driving circuit makes the voltage, which is applied to the liquid crystal display panel, to be higher gradually than a voltage which is low relatively, and in the case of extinguishing the LED, the liquid crystal driving circuit makes the voltage, which is applied to the liquid crystal display panel, to be lower gradually than a voltage which is high relatively.

10. A LED driving method, comprising:
arranging a control circuit between a direct current power source, which drives a LED, and the LED;
increasing an amount of light of the LED as the time passes in the case of starting applying a voltage to the LED by use of the direct current power source; and
decreasing an amount of the light of the LED as the time passes in the case of ending applying the voltage to the LED by use of the direct current power source.
